(19) United States
(12) Patent Application Publication
(10) Pub. No.: US 2008/0270396 A1
(43) Pub. Date: Oct. 30, 2008

(54) INDEXING VERSIONED DOCUMENT SEQUENCES

(76) Inventors: Michael Herscovici, Haifa (IL); Ronny Lempel, Haifa (IL); Sivan Yogev, Meuchad (IL)

Correspondence Address: Suzanne Erez;IBM CORPORATION, Intellectual Property Law Dept., P.O. Box 218, Yorktown Heights, NY, 10598, US

(21) Appl. No.: 11/739,700

(22) Filed: Apr. 25, 2007

(51) Int. Cl. G06F 17/30

(52) U.S. Cl. 707/6

(57) ABSTRACT

A method includes indexing text is repeated in multiple edited versions of a document, a single time, thereby generating a compact index, and conducting text searches in the compact index.

### FIELD OF THE INVENTION

The present invention relates to the processing of electronic text generally.

### BACKGROUND OF THE INVENTION

In many business applications, information systems keep multiple versions of documents. Examples include content management systems, version control systems (e.g. ClearCase, CVS), Wikis, and backup and archiving solutions. Email, where each reply or forward operation in a thread often repeats some previously sent content, can also be seen as having evolving document versions.

Often it is desired to enable free-text search over such repositories, i.e. to enable submitting queries for which there may be a match in any version of any document. A straightforward way to support free-text search over corpora of versioned documents is to index each version of each document separately, essentially treating the versions as independent entities. However, due to the inherent extensive redundancy in versioned documents, indexing them in this way invariably means indexing portions of identical material numerous times, resulting in larger indices that take longer to build and search, as well as require more storage capacity.

### SUMMARY OF THE INVENTION

There is no provided, in accordance with an embodiment of the present invention, a method including, for at least one document, indexing a single time, text which is repeated in multiple edited versions of the document, thereby generating a compact index. The method also includes conducting text searches in the index.

There is also provided, in accordance with another embodiment with another embodiment of the present invention, a search engine including an indexer to index a single time, text which is repeated in multiple edited versions of at least one document thereby generating a compact index, and a query manager to conduct text searches in the compact index.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a block diagram illustration of an innovative search engine constructed and operative in accordance with an embodiment of the present invention;

FIG. 2 is an illustration of one exemplary group of versioned documents, belonging to a collection of such groups, which collection is searched by the search engine of FIG. 1;

FIG. 3 is a block diagram illustration of the versioned document indexer component of the search engine of FIG. 1;

FIG. 4 is a graphical illustration of an exemplary alignment process performed by the indexer of FIG. 3 on the exemplary group of versioned documents of FIG. 2;

FIG. 5 is an illustration of an exemplary indexing process performed by the indexer of FIG. 3 on the exemplary group of versioned documents of FIG. 2;

FIG. 6 is a graphical illustration of the details of the exemplary virtual documents generated in the alignment process of FIG. 4;

FIG. 7 is a block diagram illustration of the compact index and query manager of the search engine of FIG. 1;

FIG. 8 is a graphical illustration of a search function performed by the query manager of FIG. 7;

FIG. 9 is a graphical illustration explaining the methodology of the search function illustrated in FIG. 8.

FIG. 10 is a graphical illustration of an additional exemplary alignment process performed by the indexer of FIG. 3; and

FIG. 11 is a block diagram illustration of a search engine constructed and operative in accordance with an additional embodiment of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Applicants have realized that when successive versions of documents are not significantly different from their predecessors, the redundancies in the documents may be exploited in order to index the documents in a compact manner, while preserving the full retrieval capabilities supported by a traditional index of the documents, in which each document is indexed as an independent entity.

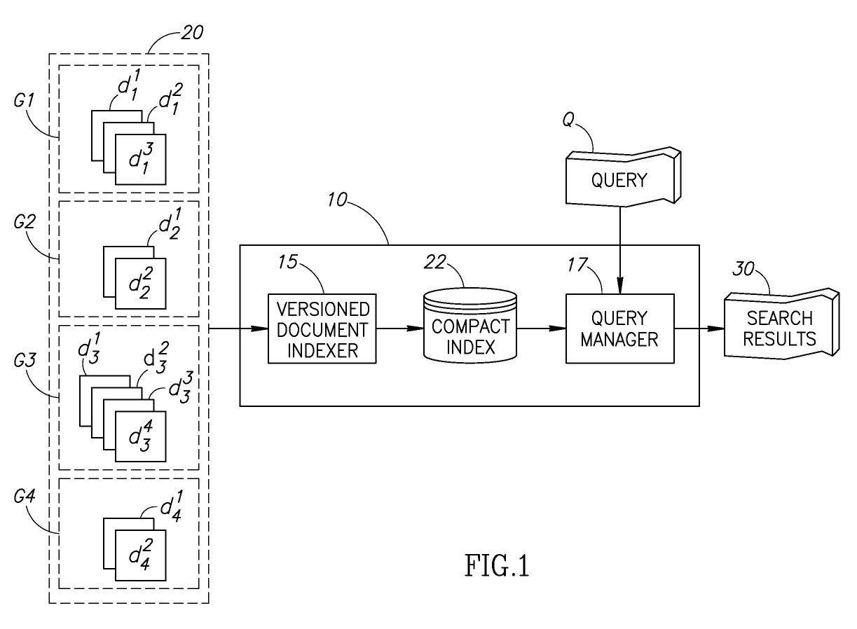

The present invention may thus provide a method and an apparatus for generating a compact index for versioned documents, and for conducting query-based searches therein. FIG. 1, reference to which is now made, is a schematic illustration of a search engine 10, constructed and operative in accordance with an embodiment of the present invention.

As shown in FIG. 1, search engine 10 may comprise a versioned document indexer 15 and a query manager 17. Versioned document indexer 15 may, in accordance with the present invention, exploit the redundancies in a collection 20 of versioned documents dᵢ^{g} in order to index them in a compact manner and produce compact index 22. Query manager 17 may receive an input query Q in which search criteria may be specified. Query manager 17 may then search compact index 22 to identify which versioned documents meet the search criteria of input query Q, and may consequently be identified as search results 30.

In accordance with the present invention, each versioned document dᵢ^{g} denotes the ith version of a document in a group g of versioned documents. Furthermore, all of the versions of a document in a group g may be related to one other by a series of revisions, i.e. insert/delete/substitute transformations. The exemplary collection 20 of versioned documents dᵢ^{g} shown in FIG. 1 comprises four groups G1-G4 of versioned documents. Group G1 is shown to comprise three versions, d₁¹, d₂¹ and d₃¹ of one document, group G2 is shown to comprise two versions d₁² and d₂² of another document, group G3 is shown to comprise four versions, d₁³, d₂³, d₃³ and d₄³ of a third document, and group G4 is shown to comprise two versions d₁⁴ and d₂⁴ of a fourth document.

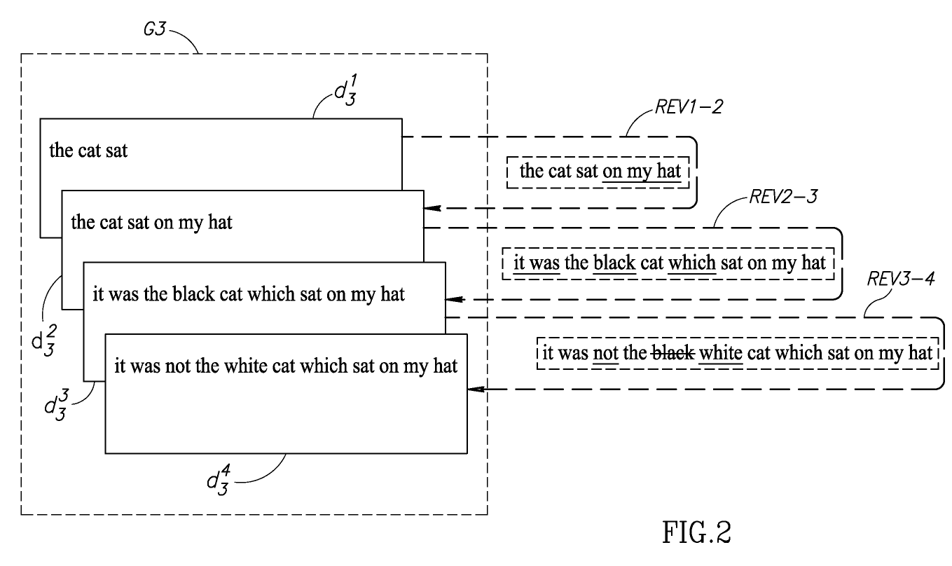

FIG. 2, reference to which is now made, shows a simplified example of a group of versioned documents having four documents related to one another by a series of revisions, such as group G3 of FIG. 1. As shown in FIG. 2, the first version of the document of group G3, document d₁³, contains the text “the cat sat”. The second version of the document of group G3, document d₂³, contains the text “the cat sat on my hat”. Arrow REV1-2 shows that document d₂³ is related to document d₁³ by the addition of the words “on my hat” after the word “sat”. Arrow REV2-3 shows that Document d₃³, containing the text “it was the black cat which sat on my hat”, is related to document d₂³ by the addition of the words “it was” before the word “the”, the addition of the word “black” before the word “cat”, and the addition of the word “which” after the word “cat”. Finally, arrow REV3-4 shows that document d₄³, containing the text “it was not the white cat which sat on my hat”, is related to document d₃³ by the addition of the word “not” after the word “was” and the substitution of the word “white” for the word “black”.

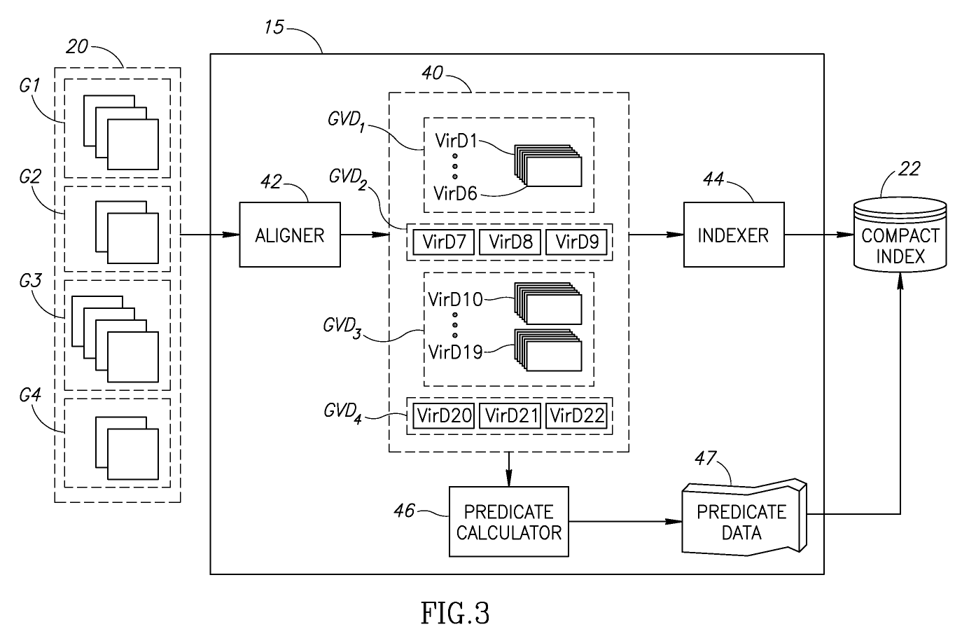

The operation of versioned document indexer 15 is discussed in further detail with respect to FIG. 3, reference to which is now made. As shown in FIG. 3, versioned document indexer 15 may comprise an aligner 42, an indexer 44, and a predicate calculator 46. Aligner 42 may, in accordance with the present invention, generate a set GVD_{g} of virtual documents VirD_{N} for each group g of versioned documents dᵢ^{g} in collection 20. Indexer 44 may create an inverted index for the entire collection 40 of virtual documents VirD_{N}. Predicate calculator 46 may calculate auxiliary predicate data 47, which may map each virtual document VirD_{N} to a range of source documents dᵢ^{g} through dⱼ^{g} (for j≧i within some document group g) in collection 20. The index created by indexer 44 and predicate data 47 calculated by predicate calculator 46 may be stored in compact index 22.

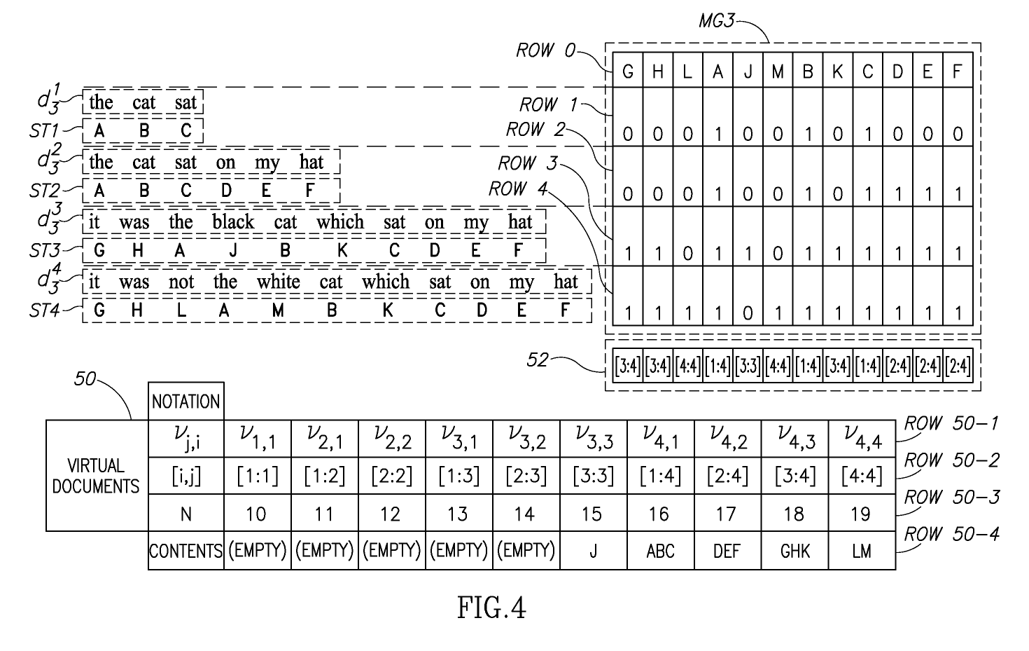

The operation of aligner 42 is discussed in further detail with respect to FIG. 4, reference to which is now made. Aligner 42 may, for each group g in collection 20, construct an alignment matrix M whose first row, row 0, is a supersequence of all of the text from which all of the documents dᵢ^{g} in a single group g are composed. Each unit of text in the supersequence may be allocated a column in alignment matrix M. In accordance with the present invention, a unit of text in the supersequence may be a word, or a group of words, such as a sentence or a paragraph, as will be discussed later in further detail.

Matrix MG3 shown in FIG. 4 is an exemplary matrix constructed by aligner 42 in accordance with the present invention for the exemplary versioned documents d₁³, d₂³, d₃³ and d₄³ of group G3, shown in FIG. 2. In the exemplary alignment of FIG. 4, the unit of text which is processed is a word. For the purpose of clarity, in the example of FIG. 4, each of the twelve words comprising the entirety of the text in the documents of group G3, i.e., “it”, “was”, “the”, “black”, “cat”, “which”, “sat”, “on”, “my”, “hat”, “not”, and “white” are assigned a letter symbol, i.e. G, H, A, J, B, K, C, D, E, F, L, and M respectively.

Each versioned document, d₁³, d₂³, d₃³ and d₄³ of group G3 may then be represented by a string of letter symbols. As shown in FIG. 4, string ST1, containing the letter symbols “ABC” represents versioned document d₁³. String ST2, containing the letter symbols “ABCDEF” represents versioned document d₂³. String ST3, containing the letter symbols “GHAJBKCDEF” represents versioned document d₃³ and string ST4, containing the letter symbols “GHLAMBKCDEF” represents versioned document d₄³.

As shown in FIG. 4, row 0 of exemplary matrix MG3 contains the supersequence “GHLAJMBKCDEF”. It will be appreciated that this text string constitutes a supersequence of the four text strings ST1, ST2, ST3 and ST4, because each of the four text strings are contained in it while the order of the symbols in each string is maintained.

Furthermore, in accordance with the present invention, each subsequent row i in alignment matrix M constructed by aligner 42 may be a binary representation of the i^{th} versioned document of group g. Thus, in exemplary matrix MG3, each exemplary string STi, representing exemplary versioned document dᵢ³, is represented by binary values in row i of the matrix. Thus, string ST1 is represented in row 1 (the first row below row 0) of matrix MG3, string ST2 is represented in row 2, string ST3 is represented in row 3 and string ST4 is represented in row 4.

As shown in FIG. 4, each text string may be translated into a binary string by assignment of a value of 1 in each column whose symbol is contained in the string and by assignment of a value of 0 in each column whose symbol is not contained in the string. Thus, as shown in FIG. 4, the binary representation of text string ST1 is “000100101000”, the binary representation of text string ST2 is “000100101111”, the binary representation of text string ST3 is “110110111111”, and the binary representation of text string ST4 is “111101111111”.

In accordance with the present invention, each versioned document represented in row i of alignment matrix M may be reconstructed from its binary representation in row i by concatenating the symbols in M_{O,j} such that M_{i,j}=1. Taking the example of string ST1 represented in row 1 of exemplary alignment matrix MG3, it may be seen that only the columns headed by the symbols A, B and C have the value of 1 in row 1 and thus, by concatenating them, the text string “ABC”, string ST1, is reconstructed.

Aligner 42 may then generate a set GVD_{g} of virtual documents for each group g of versioned documents dᵢ^{g} in collection 20. For a group g comprising n versioned documents, i.e., where i=1, . . . n, aligner 42 may generate

$$( \begin{matrix}n + 1 \\ 2\end{matrix} )$$

virtual documents {v_{j,i,}1≦i≦j≦n}. Thus for the example shown in FIG. 4, aligner 42 may generate 10 virtual documents.

In accordance with the present invention, each virtual document vⱼᵢ may contain the text in row 0 of alignment matrix M, corresponding to columns where there is a maximal run of 1s which starts at row i and ends at row j. Furthermore, the virtual documents may be ordered by a lexicographic ordering of the pair <j, i>, i.e. primarily by increasing values of the end of the runs of 1s, and within all runs ending at a particular index j, by increasing index of the beginning of the run.

Thus, as shown in row 50-1 of table 50 of FIG. 4, the ten virtual documents generated by aligner 42 for exemplary group G3 are v_{1,1}, v_{2,1}, v_{2,2}, v_{3,1}, v_{3,2}, v_{3,3}, v_{4,1}, v_{4,2}, v_{4,3} and v_{4,4}. Aligner 42 may determine the content of each of these virtual documents by finding the maximal runs of 1 in alignment matrix M. The maximal runs of 1 in exemplary matrix MG3 are shown in table 52 in FIG. 4. In table 52, the notation [i:j] is used to identify each run of 1s, where i is the row where the run of 1s starts, and j is the row where the run of 1s ends. Table 52 shows that columns G, H, L, A, J, M, B, K, C, D, E and F of exemplary alignment matrix MG3 contain maximal runs of 1 in [3:4], [3:4], [4:4], [1:4], [3:3], [4:4], [1:4], [3:4], [1:4], [2:4], [2:4] and [2:4] respectively.

It will be appreciated that while there is only one maximal run of 1s in each column of exemplary alignment matrix MG3 for the example of FIG. 4 as shown in table 52, this is only a particularity of this particular example. In accordance with the present invention, there may be multiple maximal runs of 1 in any number of columns of some alignment matrix M. For example, for a different arrangement of text in documents d₁³, d₂³, d₃³ and d₄³ of group G3, a column could have one maximal run of 1s in [1:1], and another in [3:4].

Row 50-2 of table 50 shows the virtual document in [i:j] notation which corresponds to each virtual document v_{j,i}. Row 50-4 of table 50 shows the contents of each virtual document [i:j] (and accordingly, v_{j,i}), which, in accordance with the present invention, may be the symbols in whose columns there is a run of 1s in [i:j] (i.e., rows i through j). Furthermore, in accordance with the present invention, when there are no runs of 1 in [ij] in any column of a given alignment matrix M, the corresponding virtual document [ij] may be empty.

It may thus be seen in FIG. 4 that of the ten virtual documents generated by aligner 42 for group G3, virtual documents v_{1,1}, v_{2,1}, v_{2,2}, v_{3,1}, and v_{3,2} are empty, as they do not exist in table 52. Virtual document v_{3,3}, for which there is only one entry in table 52, contains the text associated with the symbol J. There are three entries in table 52 (at A, B and C) having runs [1:4] and thus, virtual document v_{4,1} contains the text associated with the symbols A, B and C. Similarly, virtual document v_{4,2} contains the text associated with the symbols D, E and F, virtual document v_{4,3} contains the text associated with the symbols G, H and K, and virtual document v_{4,4} contains the text associated with the symbols L and M.

It will be appreciated that the example shown in FIG. 4 describes the process of transforming a single group of versioned documents, i.e., group G3 of FIGS. 1 and 2, into a single group of virtual documents, i.e., group GVD₃ of FIG. 3. In practice, however, the present invention may be used for multiple groups of versioned documents, such as are comprised by collection 20 of FIG. 1.

Given k groups of versioned documents,

d₁¹, . . . , dₙ_{₁}¹, d₁², . . . , dₙ_{₂}², . . . , d₁^{k}, . . . , dₙ_{ₖ}^{k}

aligner 42 may construct

$$N {=}^{Δ} {\sum }_{i = 1}^{k} ( \begin{matrix}{n}_{i} + 1 \\ 2\end{matrix} )$$

virtual documents in accordance with the process described with respect to FIG. 4.

The virtual documents may then be ordered as follows:

v_{1,1}¹, . . . , vₙ_{₁}_{,n}_{₁}¹, v_{1,1}², . . . , vₙ_{₁}_{,n}_{₁}², . . . , v_{1,1}^{k}, . . . , vₙ_{ₖ}_{,n}_{ₖ}^{k}

In accordance with the present invention, aligner 42 may then assign a serial number 1, . . . ,N to each virtual document, to serve as a document identifier (docid). It may be seen in FIG. 3 that aligner 42 assigned docids VirD_{N} , (i.e., VirD1-VirD22) to the 22 exemplary virtual documents of collection 40. It may further be seen in FIG. 3 that the docids assigned to the 10 virtual documents of group GVD₃ are docids VirD10-VirD19. In ROW 50-3 of table 50 in FIG. 4, the serial number N (i.e., 10-19) is listed for each virtual document v_{1,1}, v_{2,1}, v_{2,2}, v_{3,1}, v_{3,2}, v_{3,3}, v_{4,1}, v_{4,2}, v_{4,3} and v_{4,4} of group GVD₃.

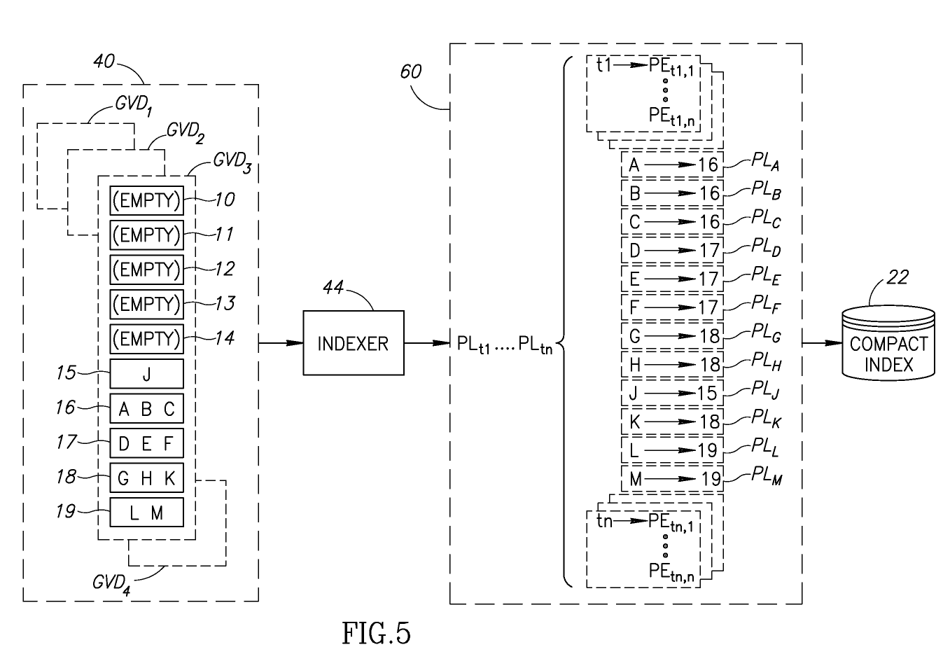

In accordance with the present invention, as explained hereinabove with respect to FIG. 3, subsequent to the generation by aligner 42 of collection 40 of virtual documents VirD_{N}, indexer 44 may index the documents in collection 40 by building an inverted index. The operation of indexer 44 is discussed in further detail with respect to FIG. 5, reference to which is now made.

As shown in FIG. 5, indexer 44 may build compact inverted index 60 in the conventional manner, i.e., by generating posting lists PLₜ₁ . . . PLₜₙ for each token t1 . . . tn appearing in a group of documents. In indexing terminology, a token refers to each unit of text, such as a word, which is indexed. Each posting list PLₜ₁ . . . PLₜₙ consists of posting elements PE_{ti,1} . . . PEₜᵢₙ, each of which indicates a location, such as a docid, identifying a particular document, where token ti can be found.

In the example of FIG. 5, indexer 44 is shown to index collection 40 of the four exemplary groups of virtual documents, GVD₁, GVD₂, GVD₃, and GVD₄ of FIG. 3. The exemplary posting lists PLₜᵢ generated by indexer 44 for virtual documents 10-19 of group GVD₃ are shown in detail in FIG. 5. It may be seen in FIG. 5 that among the posting lists PLₜ₁ . . . PLₜₙ generated by indexer 44 for the entire collection 40 of virtual documents, there is a posting list PL for each of the tokens G, H, A, J, B, K, C, D, E, F, L, and M, the letter symbols representing the words comprising all of the text in the virtual documents 10-19 of group GVD₃.

As shown in FIG. 5, the posting list for each token comprises a list of posting elements, i.e., the virtual document docids where the token may be found. Thus, the listing of the posting element ‘16’ on posting list PL_{A} for the letter symbol A, indicates that the word “the”, represented by the letter symbol A, may be found in virtual document 16. Similarly, posting lists PL_{B} and PL_{C} for the letter symbols B and C respectively, indicate that the word represented by each of these letters may be found in virtual document 16. Posting lists PL_{D}, PL_{E} and PL_{F}, for the letter symbols D, E, and F respectively, list docid 17. Posting lists PL_{G}, PL_{H} and PL_{K}, for the letter symbols G, H, and K respectively, list docid 18. Posting lists PL_{L} and PL_{M}, for the letter symbols L and M respectively, list docid 19. Posting list PL_{J} for the letter symbol J lists docid 15.

It will be appreciated that, in accordance with the present invention, the total number of posting elements that stem from group g of versioned documents in compact inverted index 60 may equal the total number of maximal runs of 1 in alignment matrix M constructed by aligner 42 for the group of virtual documents GVD_{g} associated with said group g of versioned documents. As may be seen in matrix MG3 of FIG. 4, and compact inverted index 60 of FIG. 5, for the example of group G3 of versioned documents, this number is 12.

In contrast, the total number of posting elements which would be identified in a traditional index of a group of versioned documents g, i.e., in which each document is indexed as an independent entity, would be the total number of distinct appearances of tokens. With respect to alignment matrix M, the total number of distinct appearances of tokens may be equal to the number of 1s appearing in matrix M. For the example of group G3 this number is 30, as may be seen in matrix MG3 of FIG. 4. It will further be appreciated that this number is also simply the number of words in the text of the documents of group G3.

Thus, it may be seen that indexing the virtual documents VirD_{N} in a group GVD_{g}, which may, in accordance with the present invention, represent the original versioned documents dᵢ^{g} in a group g, may produce a compact inverted index 60 having fewer posting elements than a traditional index of the documents in group g. For exemplary group G3 of versioned documents dᵢ^{g}, the number of posting elements are reduced from 30 to 12, as explained hereinabove with respect to FIGS. 4 and 5. As further shown in FIG. 5, compact inverted index 60 may be stored in compact index 22.

It will be appreciated that the ability of the present invention to afford benefits resulting from a reduced index size, without attendant detractions regarding retrieval capability, may be afforded by the maintenance of a map correlating the virtual documents VirD_{N} to the original versioned documents dᵢ^{g}. In accordance with the present invention, this map may be provided in the form of predicate data 47.

Returning briefly to FIG. 3, it may be seen that predicate data 47, calculated by predicate calculator 46, may be stored in compact index 22 along with index 60 (FIG. 5) produced by indexer 44. Predicate calculator 46 may determine the four predicates from(X), to(X), root(X), and last(X) per virtual document X=docid(v_{j,i}^{k}) as follows:

from(X)=i

to(X)=j

root(X)=docid(v_{1,1}^{k})

last(X)=docid(vₙ_{ₖ}_{,n}_{ₖ}^{k})

It will be appreciated that the predicates from(X) and to(X) map a particular virtual document X to a particular run of 1s in its associated alignment matrix M. Specifically, the value of the predicate from(X) is the row of M in which the run of 1s associated with virtual document X begins. The value of the predicate to(X) is the row of M in which the run of 1s associated with virtual document X ends.

It will further be appreciated that the predicates root(X) and last(X) map a particular virtual document X to its source group g of versioned documents dᵢ^{g}. Specifically, the value of the predicate root(X) is the docid of the first virtual document in the group GVD_{g} to which X belongs. For exemplary group of virtual documents GVD₃ of FIG. 5, the predicate root(X) for X=10-19 is docid 10.

The value of the predicate last(X) is the docid of the last virtual document in group GVD_{g} to which X belongs. Thus for exemplary group of virtual documents GVD₃ of FIG. 5, the predicate last(X) for X=10-19 is docid 19. Virtual document X may thus be associated with its source group g of versioned documents dᵢ^{g}, as explained previously hereinabove with respect to FIG. 3, by virtue of the fact that a group of virtual documents GVD_{g} is associated with group g of versioned documents d₁^{g}.

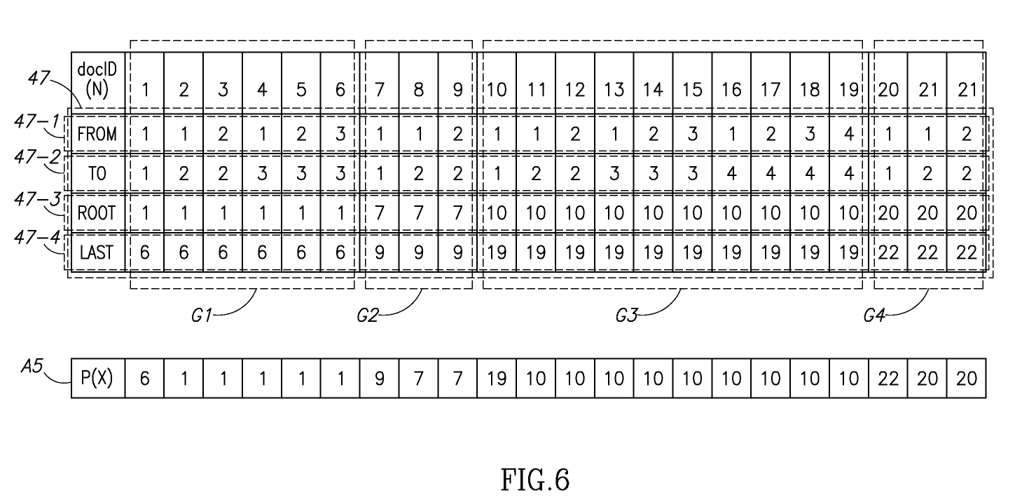

Exemplary predicate data 47 for the 22 virtual documents of exemplary collection 40 of FIG. 3 is listed in FIG. 6, reference to which is now made. For each of the 22 virtual documents 1-22, predicates from(X) are listed in row 47-1, predicates to(X) are listed in row 47-2, predicates root(X) are listed in row 47-3, and predicates last(X) are listed in row 47-4.

It may be seen in FIG. 6 how predicate data 47 may provide a complete map describing the characteristics, in terms of groups g, of a collection of versioned documents 20, and the configuration of alignment matrix M for each g. As explained previously with respect to FIG. 4, the number of virtual documents in a group GVD_{g} is strictly a function of the number n of versioned documents dᵢ^{g} in a group g. The formula,

$$( \begin{matrix}n + 1 \\ 2\end{matrix} )$$

thus determines that the exemplary groups G1, G2, G3 and G4 shown in FIG. 3, which contain three, two, four and two versioned documents dᵢ^{g} respectively, are associated with exemplary groups of virtual documents GVD₁, GVD₂, GVD₃ and GVD₄ containing six, three, ten and three virtual documents VirD_{N} respectively. This may be seen in FIG. 6 where group G1 of versioned documents is shown to be associated with the six virtual documents 1-6, group G2 of versioned documents is shown to be associated with the three virtual documents 7-9, group G3 of versioned documents is shown to be associated with the ten virtual documents 10-19, and group G4 of versioned documents is shown to be associated with the three virtual documents 20-22.

It may further be seen in FIG. 6 that the values listed for the predicates from(X) and to(X) for virtual documents X=docid(v_{j,i}^{k}) [i:j] for each group g, where from(X)=i and to(X)=j, map out the total possible variations of maximal runs of 1 for the group. The number of total possible variations of maximal runs of 1 for a group g is thus equal to the number of virtual documents VirD_{N} associated with the group. It will be appreciated that this relationship is due to the fact that the number of possible variations of runs of 1 for a group g is strictly dependent on the number of rows in matrix M_{g}, which number equals the number of versioned documents dᵢ^{g} in group g. Thus the number of virtual documents VirD_{N} associated with a group g is related by the formula

$$( \begin{matrix}n + 1 \\ 2\end{matrix} )$$

to the number n of versioned documents dᵢ^{g} in group g.

Taking the example of group G1 in FIG. 6, which has 3 versioned documents dᵢ^{g}, as shown in FIGS. 1 and 3, the formula

$$( \begin{matrix}n + 1 \\ 2\end{matrix} )$$

gives six virtual documents VirD_{N}. Six virtual documents VirD_{N} are similarly indicated by the total number (six) of different runs of 1 possible in alignment matrix MG1, which would have three rows, each one corresponding to one versioned document dᵢ^{g}: [1:1], [1:2], [2:2], [1;3], [2:3] and [3:3]. Each of these combinations is explicitly listed in the array of predicate data 47 shown in FIG. 6, where each possible run [i:j] in a group g corresponds to a virtual document X in g whose predicate from(X)=i and whose predicate to(X)=j.

It will also be appreciated that the categorization of virtual documents X into groups g is apparent in array of predicate data 47 by virtue of the fact that the values of the predicates root(X) and last(X) are shared by the virtual documents X belonging to a single group g. Thus, all of the virtual documents (1-6) of group G1 may be seen in FIG. 6 to share a root(X) of 1 and last(X) of 6. Similarly, all of the virtual documents (7-9) of group G2 may be seen in FIG. 6 to share a root(X) of 7 and last(X) of 9, all of the virtual documents (10-19) of group G3 share a root(X) of 10 and last(X) of 19, while all of the virtual documents (20-22) of group G4 share a root(X) of 20 and last(X) of 22.

It will further be appreciated that in accordance with the present invention, the values of all four predicates (i.e., from(X), to(X), root(X), and last(X)) for each virtual document X, may be available in compact index 22 at the cost of only two integers per document. Firstly, a fifth predicate, P(X), may be defined as a function of the root(X) and last(X) predicates, namely:

$$P ( X ) = \{ \begin{matrix}root ( X ) & X \neq root ( X ) \\ last ( X ) & otherwise\end{matrix}$$

That is, the value of the predicate P(X) may be equal to the value of root(X) except when X=root(X), at which time it may have the value of last(X). Exemplary values of P(X) for the 22 virtual documents of exemplary collection 40 of FIG. 3 are shown in array A5 of FIG. 6.

Furthermore, the predicates root(X), last(X) and from(X) may be calculated from the two predicates to(X) and P(X) as follows:

$$root ( X ) = min \{ X , P ( X ) \}$$

$$last ( X ) = max \{ P ( X ) , P ( P ( X ) ) \}$$

$$from ( X ) = X - root ( X ) - ( \begin{matrix}to ( X ) \\ 2\end{matrix} ) + 1$$

Thus, by storing two integers per virtual document, i.e., the two predicates to(·) and P(·), all four predicates, (i.e., from(X), to(X), root(X), and last(X)) may be readily calculable.

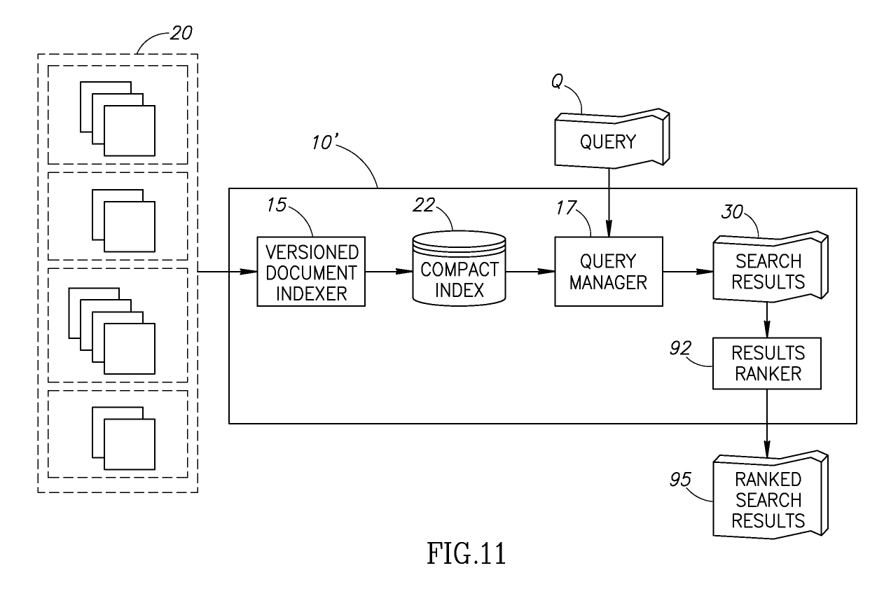

Returning now briefly to FIG. 1, given compact index 22 comprising compact inverted index 60 and predicate data 47, query manager 17 may process basic search queries, such as query Q, consisting of query terms preceded by a + operator (required term) or a—operator (forbidden term), e.g. +A+B−C. In accordance with the present invention, query manager 17 may identify the virtual documents of collection 40 (FIG. 3) which may contain all of the required terms and none of the forbidden terms of query Q. Using the predicates root, from and to, query manager 17 may then map the identified virtual documents to their corresponding original versioned documents, and identify the latter as search results 30. In an additional embodiment of the present invention, which will be discussed later with respect to FIG. 11, documents meeting the criteria of query Q may be scored and ranked before qualifying as search results 30.

In accordance with the present invention, to simplify the job of query manager 17, each forbidden term −C may be swapped with a virtual required term neg(C), which virtually appears in all of the documents in which C does not appear, and only in those documents. Formally then, a query Q may be a set of size |Q| of required terms (real and virtual), t₁, . . . ,t_{|Q|}.

During its search for terms t₁, . . . ,t_{|Q|}, query manager 17 may employ posting iterators pₜ₁, . . . ,p_{t|Q|} to mark the current position of the search in each posting list PLₜ₁, . . . ,PL_{t|Q|}. In the information retrieval (IR) literature, pₜ is also commonly known as the cursor of term t.

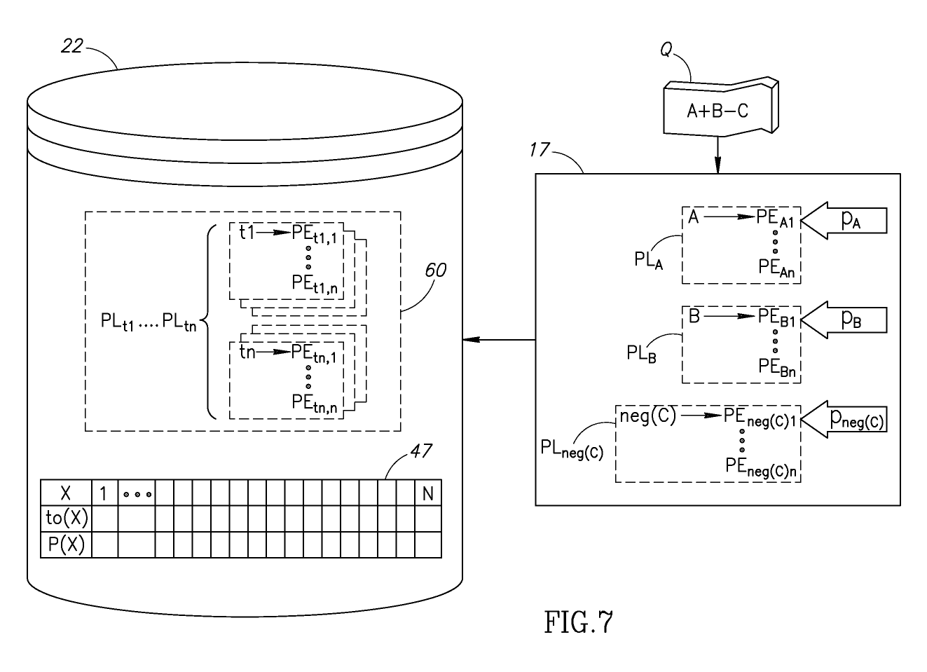

The operation of query manager 17 is discussed in further detail with respect to FIG. 7, reference to which is now made. In FIG. 7, compact index 22 is shown to comprise compact inverted index 60, comprising posting lists PLₜ₁, . . . PLₜₙ, as well as predicate data 47, at the cost of two integers per document, (i.e., to (.) and P(.)) as explained hereinabove. Exemplary query Q is shown to contain required terms A and B (i.e., +A and +B) and forbidden term C (i.e., −C). Query manager 17 may begin its search for a virtual document in collection of virtual documents 40 (FIG. 3) which may contain all of the required terms and none of the forbidden terms in query Q, by positioning iterators p_{A}, p_{B}, and p_{neg(C)} at the start of posting lists PL_{A}, PL_{B}, and PL_{neg(C)} respectively, as shown in FIG. 7.

In accordance with the present invention, query manager 17 may change the positions of iterators pₜ₁, . . . ,p_{t|Q|} in posting lists PLₜ₁, . . . ,PL_{t|Q|} in accordance with an algorithm provided in the present invention, which is a modification of the zig-zag join technique of Garcia-Molina et al. (Database System Implementation. Prentice Hall, 2000), in which the cursors of all required terms (real or virtual) are advanced in alternating order, until they align at some document id. The document at which the cursors align is that which is a match for the query.

At each step of a zig-zag join, a cursor that lags behind the most advanced cursor is chosen, and is advanced using a next operator to a point at or beyond the most advanced cursor. The algorithm provided in the present invention is a slight modification of the classic zig-zag join, since the cursor positions do not necessarily need to align at some particular virtual document, but rather on a set of virtual documents whose ranges intersect.

The standard outer shell document at-a-time evaluation provided in the present invention may be the following:

```
function search (Query Q)
    foreach term t ∈ Q do
        if t == neg(w) then
            p_{w} ← 0
        else // t is a positive term
            pₜ ← 0
        end if
    end for
    candidate ← 0
    while candidate ≠ ∞ do
        // Find a virtual document containing all required
        (real or virtual) terms
        candidate ← nextCandidate(candidate)
        output candidate
    end while
end function
```

The search function enumerates all virtual documents which match the query Q. It outputs a virtual document if and only if the range of physical documents corresponding to it and none of the forbidden terms.

The nextCandidate function performs the zig-zag join and returns the virtual document id representing the next range on which all cursors intersect. The nextCandidate functon employs the primitive next(pₜ, docid), the function location(root, from, to), and the function intersection(docid1, docid2).

In accordance with the present invention, the primitive next(pₜ, docid) sets pₜ to the first virtual document in the posting list of t whose id is greater than docid (or to ∞ if no such document exists) and returns that document id.

The function location(root, from, to) returns the id of the virtual document corresponding to the range [from, to], given the id of the virtual root document (corresponding to the range [1, 1]) of a group of versional documents. This may simply be calculated as:

$$location ( root , from , to ) = root + ( from - 1 ) + ( \begin{matrix}to \\ 2\end{matrix} )$$

The function intersection(docid1, docid2) returns the id of the virtual document that corresponds to the intersection of the ranges resented by docid1 and docid2, or ∞ if the ranges do not intersect.

In accordance with the present invention, the function which may perform the zig-zag join and return the virtual document id representing the next range on which all cursors intersect is the following:

```
function nextCandidate (docid)
    // advance t₁ beyond the last document in docid's range
    nextd ← next(t₁,location(root(docid),to(docid),to(docid)))
    align ← 2
    // perform a zig - zag join on ranges of virtual documents
    while (align ≠ |Q| + 1) [symbol] (nextd ≠ ∞ )do
        // advance term t_{align} to or beyond the beginning of nextd's range
        temp ← next (t_{align},location(root(nextd),1, from(nextd))−1)
      // surely now to(temp) ≧ from(nextd)
      if (root(temp) == root(nextd)) [symbol] (from(temp) ≦ to(nextd))then
        nextd ← intersection(nextd,temp)
        align ← align + 1
      else
        nextd ← next(t₁,location(root(temp),1, from(temp))−1)
        align ← 2
      end if
    end while
    return nextd
end function
```

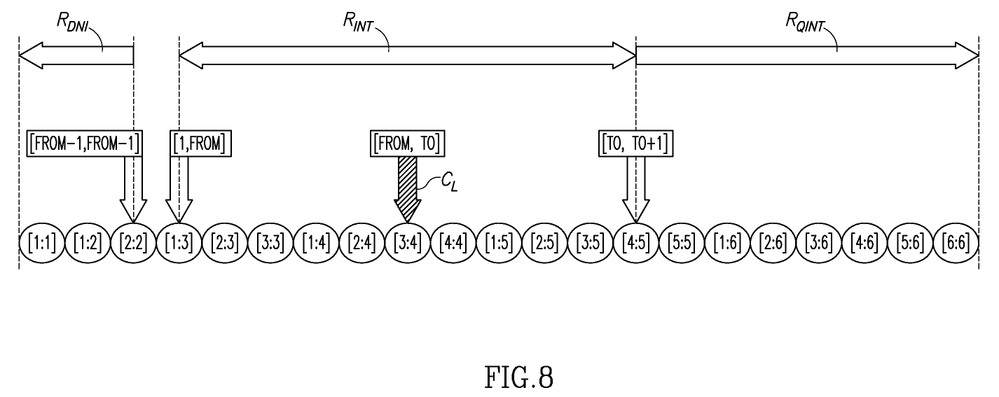

FIG. 8 reference to which is now made, illustrates how the nextCandidate function may operate in acordance with the presebt invention to perform the zig-zag join and return the virtual document id representing the next range on which all cursors intersect. FIG. 8 shows an exemplary group GVDₓ of 21 virtual documents numbered [1:1] . . . [6:6], which represent 6 original versioned documents dᵢ^{x}.

As shown in FIG. 8, the leading cursor C_{L} may be on a virtual document representing an interval [from, to ] in some group g. In the example shown in FIG. 8, leading cursor C_{L} is located in the virtual document [3:4]. In accordance with interval algebra, all virtual documents before [1,from], ie., virtual documents at or before from [from−1, from−1], of the same group g represent intervals which do not intersect with the range of leading cursor C_{L}. Thus, for the example of FIG. 8, all virtual documents before and including virtual document [2:2] do not intersect with the range of leading cursor C_{L}. Reference numeral R_{DNI}, in FIG. 8 indicates the range of virtual documents before virtual document [2:2] which does not intersect with the range of leading cursor C_{L}.

Furthermore, as shown in FIG. 8, all virtual documents in the range [1,from] . . . [to,to+1] of the same group g, represent intervals that surely intersect with the range of cursor C_{L} In FIG. 8, this range is indicated by the reference numeral R_{INT}, and includes the virtual documents from [1:3] to [4:5].

The virtual documents beyond [to,to+1] will either not intersect at all with the range of cursor C_{L}, or will intersect with the suffix of the range of cursor C_{L} In FIG. 8, this range is indicated by the reference numeral R_{QINT}, and includes the virtual documents beyond [4:5].

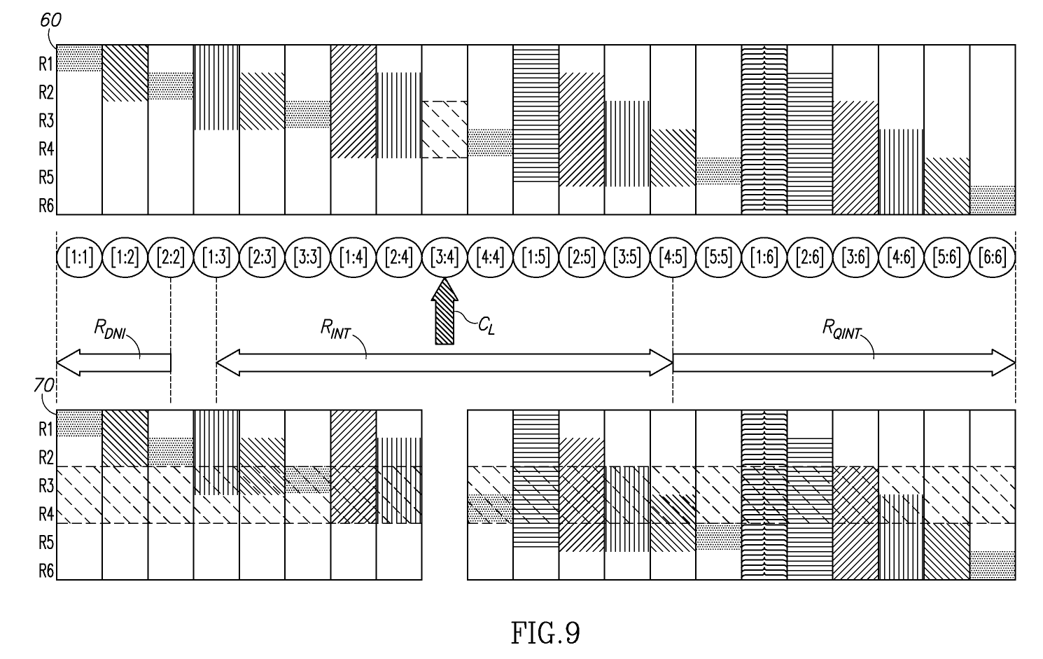

FIG. 9, reference to which is now made, shows graphically how the range of cursor C_{L} from the example of FIG. 8, i.e. the interval [3:4], does not intersect with the intervals in range R_{DNI}, surely intersects with the intervals in range R_{INT}, and may possibly intersect with the intervals in range R_{QINT}.

In graphs 60 and 70 shown in FIG. 9, rows 1-6 of each graph are indicated by the numerals R1-R6. As in alignment matrix M, each row i may correspond to the ith versioned document dᵢ^{x} of group x, such that the six rows in graphs 60 and 70 may correspond to the six original versioned documents dⁱ^{x} represented by the 21 virtual documents numbered [1:1] . . . [6:6] of FIGS. 8 and 9.

In graph 60 each virtual document [ij] is represented as an interval spanning row i to row j, by a hatching pattern filling the interval. In graph 70, the graphical intersection between virtual document [3:4] and each of the other virtual documents, is shown by an overlay of the hatching pattern of virtual document [3:4] over the hatching pattern of every other interval. Thus the characteristics of intersection of ranges R_{DNI}, R_{INT} and R_{QINT}, as a function of the range of the interval [i:j] of the leading cursor C_{L}, are demonstrated.

As shown in FIG. 9, when the hatching pattern on interval [3:4] of leading cursor C_{L} is overlaid on the hatching patterns of each of the intervals of the virtual documents in range R_{DNI} (i.e. virtual documents [1:1], [1:2], and [2:2]) it may be seen that there is no overlap between the hatching patterns. Thus it is shown in FIG. 9, as stated previously hereinabove with respect to FIG. 8, that there is no intersection between the interval of leading cursor C_{L} and the intervals at or before [from−1, from−1] when leading cursor C_{L} is located on the interval [from:to].

Conversely, when the hatching pattern on interval [3:4] of leading cursor C_{L} is overlaid on the hatching patterns of each of the intervals of the virtual documents in range R_{INT}, (i.e. virtual documents [1:3]-[4:5]) it may be seen that the hatching patterns always overlap. Thus it is shown in FIG. 9, as stated previously hereinabove with respect to FIG. 8, that the interval of leading cursor C_{L} will surely intersect with the intervals in the range of [1,from] . . . [to, to+1] when leading cursor C_{L} is located on the interval [from:to].

Finally, when the hatching pattern on interval [3:4] of leading cursor C_{L} is overlaid on the hatching patterns of each of the intervals of the virtual documents in range R_{QINT,} (i.e. virtual documents [4:5]-[6:6]) it may be seen that the hatching patterns overlap in intervals [1:6], [2:6], [3:6] and [4:6], and that the hatching patterns do not overlap in intervals [5:5], [5:6] and [6:6]. Thus it is shown in FIG. 9, as stated previously hereinabove with respect to FIG. 8, that the interval of leading cursor C_{L} will intersect with the intervals after [to, to+1] which include the suffix of the range of leading cursor C_{L} (i.e., [to]) when leading cursor C_{L} is located on the interval [from:to]. This is demonstrated in the example of FIG. 9 where the intervals in which there is an overlap of hatching patterns, i.e., [1:6], [2:6], [3:6] and [4:6], span the suffix of the range of leading cursor C_{L} (is., 8 4]), while the intervals in which there is no overlap of hatching patterns ie., [5:5], [5:6] and [6:6] , do not span row R4 at all.

Furthermore, in accordance with the method of the modified zig-zag join provided in the present invention, if a lagging cursor is advanced and it hits a non-intersecting range, it is guaranteed to not intersect with the range of the leading cursor C_{L} later, so that leading cursor C_{L} may be switched.

As explained preciously hereinabove, a forbidden term −C of query Q may be wrapped with a virtual cursor, which may use the underlying cursor to return the next interval in which C does not appear. In accordance with the present invention, the next function of the virtual cursor corresponding to a negative term may be implemented as follows:

```
function next(p_{t=neg(w),}docid)
    // Invariant : from(docid) always equals to(docid)
    if docid ≧ p_{w} then
      p_{w} ← next(p_{w},docid)
    end if
    target ← docid + 1
    // we now know that to(p_{w})is at or beyond to(target)
    if (p_{w} = ∞) [symbol] (root(p_{w}) > root(target))then
      // return the id corresponding to the range that starts at to(target)
      // and continues until the end of target's version group
      Pₜ ← location (root(target),to(target),to(last(target)))
      return pₜ
    end if
    // here we know that p_{w} and target share the same root
    if from(p_{w}) > to(target)then
      // return the id corresponding to the range [to(target),from(p_{w})−1]
      pₜ ← location(root(target),to(target),from(p_{w})−1)
      return pₜ
    end if
    // the range of p_{w} immediately follows docid; we therefore
    apply tail recursion
    pₜ ← nexr(pₜ,locarion(root(target),to(p_{w}),to(p_{w})))
end function
```

It will be appreciated that the virtual cursor wrapper may remember the last position to which the underlying cursor was advanced. Furthermore, the next method of the wrapper may be called with a range of the form [X,X]. It will further be appreciated that for each group, the last physical document in the group may be identified as the document having the largest “to ” value of any range in the group.

As discussed previously hereinabove with respect to FIG. 5, the size of compact index 60 is primarily a function of the number of maximal runs of 1 in alignment matrix M. Applicants have realized that a greedy polynomial-time algorithm may be employed in the present invention to configure alignment matrix M such that the number of maximal runs of 1 in M is minimized and the savings in index size is maximized.

The greedy polynomial-time algorithm provided in the present invention may be used for groups of versioned documents which evolve in a linear fashion, i.e., the versions are sequential and do not branch. For document versions which evolve in a treelike fashion, the method of DFS traversal may be used to configure alignment matrix M.

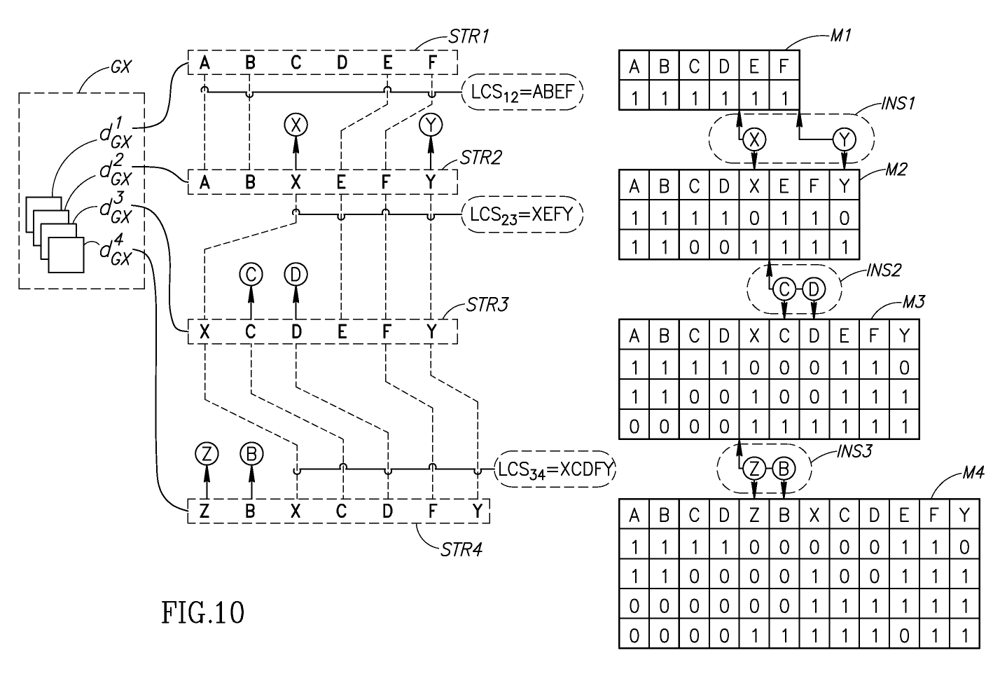

FIG. 10, reference to which is now made, shows how an alignment matrix M may be configured for an exemplary group of versioned documents in accordance with the greedy polynomial-time algorithm provided in the present invention. In the example shown in FIG. 10, exemplary group GX comprises versioned documents d₁^{GX}, d₂^{GX}, d₃^{GX} and d₄^{GX} where the documents are ordered in the sequence in which they were created. That is, in the example of FIG. 10, document d₁^{GX} is the first version of the group GX document, document d₂^{GX} is the second version, document d₃^{GX} is the third version, and document d₄^{GX} is the fourth version.

In the example of FIG. 10, as in FIG. 4, documents d₁^{GX}, d₂^{GX}, d₃^{GX} and d₄^{GX} are represented by strings STR1, STR2, STR3 and STR4 (respectively) of letter symbols. As explained previously hereinabove, each strings STRi is a simple representation of its respective textual document, where each letter symbol represents a unit of text such as a word, sentence or paragraph. In the example of FIG. 10, string STR1 is the sequence “ABCDEF”, string STR2 is the sequence “ABXEFY”, string STR3 is the sequence “XCDEFY”, and string STR4 is the sequence “ZBXCDFY”.

In accordance with the greedy polynomial-time algorithm provided in the present invention and as shown in FIG. 10, alignment matrix M may be built for a group of versioned documents by beginning with an initial matrix M1 which may be associated with the first versioned document in the group. Initial matrix M1 may then be expanded further into subsequent matrices Mj, each of which may be associated with versioned document j, where j=2, . . . n for a group of versioned documents containing n versions.

Initial matrix M1 may contain the string representing the first versioned document in its uppermost row, with a column allocated to each symbol in the string (i.e., each unit of text in the document version). The row below the uppermost row may be associated with the first versioned document, and may contain values of 1 in each cell. A value of 1 in a cell may indicate the appearance of the symbol associated with its column in the string associated with its row, as explained previously with respect to FIG. 4. Therefore, since the uppermost row of initial matrix M1 contains only the symbols in the first string, the row associated with the first string, i.e. the first row below the uppermost row, contains only values of 1.

Each matrix expansion may then be performed by computing the longest common subsequence (LCS) of the strings representing versioned document j and versioned document j-1, and then inserting new columns into matrix M(j-1) for all symbols in string j inserted relative to string j-1. Each expanded matrix Mj also includes a row added to matrix M(j-1) which contains a binary representation of versioned document j, as explained previously with respect to FIG. 4. The last expanded matrix Mj for j=n may be alignment matrix M for the group of versioned documents.

Thus, in the example of FIG. 10, initial matrix M1 is shown to have six columns, containing the six letter symbols “ABCDEF” of string STR1 in its uppermost row, and the value of 1 in each column in the following row. Then initial matrix M1 is expanded to matrix M2 by determining the longest common subsequence (LCS) of string STR1 “ABCDEF” and string STR2 “ABXEFY”. As shown in FIG. 10, the LCS of strings STR1 and STR2, referred to as LCS₁₂, is “ABEF”. Then, the letter symbols contained in string STR2 but not contained in LCS₁₂, are inserted into initial matrix M1 to form expanded matrix M2. As shown in diagram INS1 of FIG. 10, matrix M2 is thus formed by inserting columns for the letters X and Y after the letters D and F respectively, since these are the letters inserted into string STR2, “ABXEFY”, relative to string STR1, “ABCDEF”.

To finalize the creation of expanded matrix M2, a row containing the binary representation of STR2 is appended to matrix M2. The binary representation of STR1 is also updated to contain zero values in the columns inserted into matrix M2 since their symbols are not contained in STR1.

Similarly, and as shown in FIG. 10, for the expansion from matrix M2 to matrix M3, LCS₂₃ is “XEFY”, leaving the letters C and D to be inserted after the letter X in matrix M2, as shown in diagram INS2. For the expansion from matrix M3 to M4, LCS₃₄ is “XCDFY”, leaving the letters Z and B to be inserted after the letter D in matrix M3, as shown in diagram INS3.

FIG. 11, reference to which is now made, shows a search engine 10′ constructed and operative in an additional embodiment of the present invention. Search engine 10′ may comprise all of the components of search engine 10 of FIG. 1, with the addition of results ranker 92 which may rank search results 30 according to their relevance to query Q, and return ranked search results 95. Typically, in order to perform relevance ranking of this sort, search systems must enumerate the occurrences of all query terms in each matching document.

The method provided in the present invention may support such ranking in the following manner: Whenever query manager 17 returns a virtual document V_{to, from}^{k} representing the range [from,to] of version group k, from the nextCandidate function as search results 30, results ranker 92 may score the to−from+1 physical versioned documents represented by that range. Query manager 17 may stream through the postings lists of all positive query terms, starting from virtual document V_{from,1}^{k} and ending at v_{to,to}^{k}, and results ranker 92 may factor each query term occurrence within those virtual documents into the scores of the corresponding physical versioned documents.

The present invention may thus be able to return results matching any of the following criteria for every group k in which some document matched query Q: the earliest or latest document version matching query Q, the highest-scoring version with respect to query Q, or all of the versions matching query Q.

It will be appreciated that search engines typically associate inner-document locations with each indexed token, thus mapping adjacencies of tokens in a document. This enables both exact-phrase searching, as well as proximity-based scoring (i.e., boosting the score of documents where query terms appear in close proximity to one another.) It will further be appreciated that phrase matching and proximity-based scoring do not typically cross sentence boundaries.

As discussed previously hereinabove with respect to FIG. 4, each unit of text allocated a column in alignment matrix M by aligner 42 may be a word, or a group of words, such as a sentence or a paragraph. However, if the unit of text used is a word, the alignment process provided in the present invention may distribute the words contained in a single physical document to several virtual documents. Word co-occurrence patterns may thus not be maintained, and the performance of exact-phrase queries and proximity-based searches may be impaired.

The method provided in the present invention may maintain robust performance of exact-phrase queries and proximity-based searches when the unit of text used by aligner 42 is at least a sentence. Versioned document indexer 15 may align each versioned document by sentences, hashing each sentence into an integer value, and transforming each document into a sequence of integers. The integers may then be aligned, and when assigned to the virtual documents, each integer may be replaced by the sentence it represents. Sentences may thus be kept intact, and exact-phrase queries and proximity-based searches may be reliably performed.

It will be appreciated that indexing documents aligned by sentences may result in lesser index space savings in comparison with documents aligned by individual words, since any change in a sentence between version i and i+1 of a document will require the re-indexing of the entire sentence in some new virtual document. On the other hand, the alignment phase may run much faster when the unit of text is a sentence, since the sequences to align may be much shorter.

It will further be appreciated that while the greedy polynomial-time algorithm discussed hereinabove with respect to FIG. 10 may be the optimal method for configuring alignment matrix M when the unit of text used is a word, when the unit of text used is a sentence, this algorithm may be modified in order to obtain the optimal method for configuring alignment matrix M. Specifically, when the unit of text used in M is a sentence, the Needleman-Wunsch algorithm (Needleman, S., Wunsch, C. A general method applicable to the search for similarities in the amino acid sequence of two proteins. J. Molecular Biology 48(3) 1970, 443-453) may be used in accordance with the present invention when aligning row i with row i−1.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. A method comprising:
for at least one document, indexing a single time, text which is repeated in multiple edited versions of said document thereby generating a compact index; and
conducting text searches in said compact index.

2. The method according to claim 1 wherein said versions of each said at least one document form a group and wherein said indexing comprises:
generating a set of virtual documents for each said group;
indexing said virtual documents; and
recording mapping data correlating said virtual documents to said versions.

3. The method according to claim 2 and comprising associating each instance of repetition of said text in at least two successive said versions with a single appearance of said text in one of said virtual documents.

4. The method according to claim 2 and wherein said generating comprises:
defining an alignment for each said group; and
deriving said set of virtual documents from said alignment.

5. The method according to claim 4 and wherein said defining comprises building a matrix whose first row is a supersequence of the entirety of text in each said group and each of whose subsequent rows is a binary representation of each of said versions.

6. The method according to claim 5 and wherein said building comprises assigning a column in said matrix for each unit of text in said entirety of text.

7. The method according to claim 6 and comprising:
assigning a first value in each cell of said matrix when said column associated with said cell is associated with a particular said unit of text which appears in said version associated with said row associated with said cell; and
otherwise assigning a second value in said cell.

8. The method according to claim 5 and wherein said deriving comprises associating one combination of contiguous said rows of said matrix with one said virtual document.

9. The method according to claim 8 and wherein textual content of each said virtual document associated with a particular said combination comprises each said unit of text associated with each said column in said matrix in which there is a maximal run of said first value in said particular combination.

10. The method according to claim 5 and comprising ordering said versions in said subsequent rows according to their time of creation when said versions evolve in a linear manner.

11. The method according to claim 5 and comprising ordering said versions in said subsequent rows using DFS (Depth First Search) traversal when said versions evolve in a treelike manner.

12. The method according to claim 6 and wherein each said unit of text is one of the following: a word, a sentence and a paragraph.

13. A search engine comprising:
an indexer to index a single time, text which is repeated in multiple edited versions of at least one document thereby generating a compact index; and
a query manager to conduct text searches in said compact index.

14. The search engine according to claim 13 wherein said versions of each said at least one document form a group and wherein said indexer comprises an aligner to generate a set of virtual documents for each said group and a predicate calculator to calculate mapping data correlating said virtual documents to said versions.

15. The search engine according to claim 14 and wherein said aligner associates each instance of repeating of said text in at least two successive said versions with a single appearance of said text in one of said virtual documents.

16. The search engine according to claim 15 and wherein said each instance comprises the repetition of a unit of said text wherein said unit is one of the following: a word, a sentence, and a paragraph.

17. A computer product readable by a machine, tangibly embodying a program of instructions executable by the machine to perform method steps, said method steps comprising:
for at least one document, indexing a single time, text which is repeated in multiple edited versions of said document thereby generating a compact index; and
conducting text searches in said compact index.

18. The computer product according to claim 17 and wherein said versions of each said at least one document form a group and wherein said indexing comprises:
generating a set of virtual documents for each said group;
indexing said virtual documents; and
recording mapping data correlating said virtual documents to said versions.

19. The computer product according to claim 18 and comprising associating and each instance of repetition of said text in at least two successive said versions with a single appearance of said text in one of said virtual documents.

20. The computer product according to claim 18 and wherein said generating comprises:
defining an alignment for each said group; and
deriving said set of virtual documents from said alignment.
